(19) United States
(12) Patent Application Publication
(10) Pub. No.: US 2010/0319047 A1
(43) Pub. Date: Dec. 16, 2010

(54) DIGITAL BROADCAST RECEIVER

(75) Inventors: Toshikazu MITSUTAKE, Kanagawa (JP); Noritaka Shimizu, Kanagawa (JP); Rie Fukushige, Kanagawa (JP)

Correspondence Address: MCDERMOTT WILL & EMERY LLP, 600 13TH STREET, NW, WASHINGTON, DC, 20005-3096, US

(73) Assignee: Panasonic Corporation, Osaka (JP)

(21) Appl. No.: 12/817,691

(22) Filed: Jun. 17, 2010

Related U.S. Application Data
(63) Continuation of application No. PCT/JP2009/001251, filed on Mar. 19, 2009.

(30) Foreign Application Priority Data
Mar. 31, 2008 (JP) P2008-091249

(51) Int. Cl. H04N 7/16

(52) U.S. Cl. 725/139

(57) ABSTRACT

There is provided a digital broadcast receiver that can readily cope with a change in a time lag between simultaneous broadcasts and opening of a new broadcast station and that enables smooth switching between the simultaneous broadcasts without addition of devices entailing performance of enormous amounts of processing. A characteristic showing that a coding rate increases when a large difference arises between a current frame and a preceding frame of a video signal is utilized for MPEG2 and MPEG4-AVC standards employed as schemes for coding a video signal in a ground digital broadcast. A per-frame coding rate of first broadcast coded video data and a per-frame coding rate of second broadcast coded video data are ascertained. A lag between an output time of the first broadcast and an output time of the second broadcast is detected from time shifts in the thus-ascertained coding rates and a lag between internal clock signals. The output time of the first broadcast video frame and the output time of the first broadcast audio frame are delayed by an amount corresponding to the output time lag. Either the first broadcast or the second broadcast is selected according to predetermined conditions, and the thus-selected broadcast is displayed on a display.

### BACKGROUND

1. Field of the Invention

The present invention relates to a digital broadcast receiver that receives and displays digital broadcasts which provide a program of single contents by different means.

2. Description of the Related Art

In a ground digital broadcast, a digital broadcast band for one channel is divided into thirteen segments. A high-resolution video is provided to a fixed receiver by use of twelve segments of the thirteen segments. Further, a low resolution video compliant with a transmission technique exhibiting high resistance to a transmission error is provided by use of a remaining one segment.

Further, a simulcast scheme is adopted by the current ground digital broadcast, and a program of single contents simultaneously provided as a 12-segment broadcast using 12 segments and a one-segment broadcast using one segment. As mentioned above, simultaneously broadcasting a program of single contents through use of different means is called a simultaneous broadcast.

For instance, a vehicle-mounted digital broadcast receiver is equipped with a high resolution monitor and adopts means that displays a high resolution video provided by the 12-segment broadcast as much as possible even when the vehicle is on the move and that switches the 12-segment broadcast to the one-segment broadcast exhibiting high resistance to a transmission error when a receiving state has become deteriorated.

In a digital broadcast, a Presentation Time Stamp (hereinafter called simply “PTS”) that is display time information is transmitted in association with a video and audio. In a receiver, a reference time generated from Program Clock Reference (hereinafter called simply “PCR”) information included in a Transport Stream (hereinafter called simply “TS”) packet generated as a result of demodulation of a broadcast radio wave is shared between the video and the audio for synchronization therebetween.

However, the 12-segment broadcast and the one-segment broadcast are not necessarily identical with each other in terms of the PCR and the PTS. For this reason, when switching between the 12-segment broadcast and the one-segment broadcast takes place, a video and audio sometimes become discontinuous.

In order to solve the problem, methods have hitherto been proposed. One method is to hold for each broadcast station an offset table showing a time lag between display timing of the 12-segment broadcast and display timing of the one-segment broadcast, and a display lag time is controlled (see; for instance, Patent Document 1). Another method, is to compare a broadcast signal transmitted by way of a 12-segment broadcast channel with a broadcast signal transmitted by way of a one-segment broadcast channel, thereby detecting a time lag between display timings or an amount of delay (see; for instance, Patent Document 2).

Patent Document 1: JP-A-2007-49460

Patent Document 2: JP-A-2007-49410

However, under the method described in connection with Patent Document 1, when the broadcast station has changed a delay time or when a new broadcast station is opened, a correction must be made to the offset table. Further, under the method described in connection with Patent Document 2, a comparison between broadcast signals entails performance of enormous amounts of processing, and circuits specifically designed for that purpose are required. For these reasons, the second method is unsuitable for a compact mobile device required to be power thrifty.

### SUMMARY

An objective of the present invention is to provide a digital broadcast receiver that can perform switching between simultaneous broadcasts without necessitating a correction to a program, such as table data, even when a time lag between simultaneous broadcasts is changed or when a new broadcast station is opened, without necessitating addition of a device for performing comparison between sets of data pertaining to simultaneous broadcast entailing performance of enormous amounts of processing, and without provoking an uncomfortable feeling among audiences.

In the present invention, in order to solve the drawbacks, there is calculated a time lag between a 12-segment broadcast and a one-segment broadcast by checking a time shift in a coding rate of 12-segment broadcast coded video data against a time shift in a coding rate of one-segment broadcast coded video data. Further, the present invention is not limited to the 12-segment broadcast and the one-segment broadcast. For this reason, descriptions are provided hereunder while the 12-segment broadcast is taken as a first broadcast and while the one-segment broadcast is taken as a second broadcast.

MPEG2 and MPEG4-AVC standards employed as schemes for coding a video signal in a ground digital broadcast bear a characteristic showing that a coding rate increases when a large difference arises between a current frame and a preceding frame of a video signal for reasons of a scene change. By utilization of the characteristic, it is possible to calculate a time lag between a first broadcast and a second broadcast from a lag between a time when a time shift in the coding rate of the first broadcast coded video data becomes maximum and a time when a time shift in the coding rate of the second broadcast coded video data becomes maximum.

The present invention provides a digital broadcast receiver that receives and displays a digital broadcast which provides a program of single contents by different means, comprising: a demodulation section that demodulates a first broadcast wave and a second broadcast wave and that outputs Transport Stream (hereinafter referred to as a “TS”) packets of the respective waves; a TS decoder that extracts, from the TS packets output from the demodulation section, first broadcast coded audio data, first broadcast coded video data, second broadcast coded audio data, and second broadcast coded video data; an internal clock signal generation section that generates an internal clock signal synchronous with a first broadcast Program Clock Reference (hereinafter referred to as a “PCR”) included in the TS packet and an internal clock signal synchronous with a second broadcast PCR included in the TS packet; a coded video data buffer that stores the first broadcast coded video data and the second broadcast coded video data; a coded audio data buffer that stores the first broadcast coded audio data and the second broadcast coded audio data; a video decoder that decodes the first broadcast coded video data and the second broadcast coded video data stored in the coded video data buffer, thereby outputting a first broadcast video frame and a second broadcast video frame; an audio decoder that decodes the first broadcast coded audio data and the second broadcast coded audio data stored in the coded audio data buffer, thereby outputting a first broadcast audio frame and a second broadcast audio frame; a PTS and coding rate storage section that detects a per-frame coding rate and a Presentation Time Stamp (hereinafter referred to as a “PTS”) value from each of the first broadcast coded video data and the second broadcast coded video data stored in the coded video data buffer and that stores a time shift in connection with the first broadcast and a time shift in connection with the second broadcast; a time lag detection section that detects a time lag between an output time of the first broadcast and an output time of the second broadcast from a time shift in the coding rate of the first broadcast coded video data and a time shift in the coding rate of the second broadcast coded video data, which are stored in the PTS and coding rate storage section, and also from a lag between the internal clock signal of the first broadcast and the internal clock signal of the second broadcast; a delay control section that delays an output time of the first broadcast video frame and an output time of the first broadcast audio frame by an amount corresponding to the output time lag detected by the time lag detection section; and a switching section that displays on a display, according to a predetermined condition, either the first broadcast video frame and the first broadcast audio frame output from the video decoder and the audio decoder while delayed by the amount corresponding to the output time lag or the second broadcast video frame and the second broadcast audio frame output from the video decoder and the audio decoder.

By means of the configuration, a time lag between an output time of the first broadcast and an output time of the second broadcast is detected from a time shift in the coding rate of the first broadcast coded video data and a time shift in the coding rate of the second broadcast coded video data and also from a lag between the internal clock signal of the first broadcast and the internal clock signal of the second broadcast. An output time of the first broadcast video frame and an output time of the first broadcast audio frame are delayed by an amount corresponding to the output time lag detected by the time lag detection section. According to a predetermined condition, either the first broadcast or the second broadcast is displayed on the display. Therefore, even when a time lag between simultaneous broadcasts is changed or when a new broadcast station is opened, the receiver can readily track broadcasts and perform smooth switching between simultaneous broadcasts without necessitating addition of devices entailing performance of enormous amounts of processing.

Moreover, in the digital broadcast receiver of the present invention, the time lag detection section detects a time lag between an output time of the first broadcast and an output time of the second broadcast from a PTS value achieved when the coding rate of the first broadcast coded video data becomes maximum through a time shift and a PTS value achieved when the coding rate of the second broadcast coded video data becomes maximum through a time shift.

By means of the configuration, a PTS value achieved when the coding rate of the first broadcast coded video data becomes maximum through a time shift and a PTS value achieved when the coding rate of the second broadcast coded video data becomes maximum through a time shift are ascertained, whereby a lag between an output time of the first broadcast and an output time of the second broadcast is detected. Therefore, even when a time lag between simultaneous broadcasts is changed or when a new broadcast station is opened, the receiver can accurately track broadcasts and perform switching between simultaneous broadcasts without provoking an uncomfortable feeling among audiences.

Further, in the digital broadcast receiver of the present invention, the time lag detection section calculates a lag between a reference time of the PTS value imparted to the first broadcast video frame and the first broadcast audio frame and a reference time of the PTS value imparted to the second broadcast video frame and the second broadcast audio frame, from a lag between a value of the internal counter calculated from the PCR included in the TS packet of the first broadcast and a value of the internal counter calculated from the PCR included in the TS packet of the second broadcast.

Since the first broadcast and the second broadcast are not always identical with each other in terms of the PCR that serves as a reference time, it is not possible to make a simple comparison between a PTS value at which the coding rate of the first broadcast coded video data becomes maximum through a time shift and a PTS value at which the coding rate of the second broadcast coded video data becomes maximum through a time shift. However, by means of the configuration, a lag between the internal clock signal synchronous with the PCR of the first broadcast and the internal clock signal synchronous with the PCR of the second broadcast is determined, to thus make a correction to a reference time. It hereby becomes possible to make a comparison between the PTS values at which the coding rates of the coded video data become maximum through the time shift, and hence a lag between an output time of the first broadcast and an output time of the second broadcast can accurately be detected.

The digital broadcast receiver of the present invention enables seamless switching between simultaneous broadcasts without addition of devices entailing performance of enormous amounts of processing to make a comparison between sets of data pertaining to simultaneous broadcasts. Moreover, even when a time lag between simultaneous broadcasts is changed or when a new broadcast station is opened, the digital broadcast receiver can address the change without necessitating a correction to a program, such as table data.

### BRIEF DESCRIPTION OF THE DRAWINGS

FIG. 1 is a block diagram showing a configuration of a digital broadcast receiver of an embodiment of the present invention.

FIG. 2 is a graph showing a time shift in a coding rate of first broadcast coded video data and a time shift in a coding rate of second broadcast coded video data.

FIG. 3 is a graph showing a time shift in a coding rate of first broadcast coded video data and a time shift in a coding rate of second broadcast coded video data corrected by use of a reference time offset.

### DESCRIPTION OF THE PREFERRED EMBODIMENTS

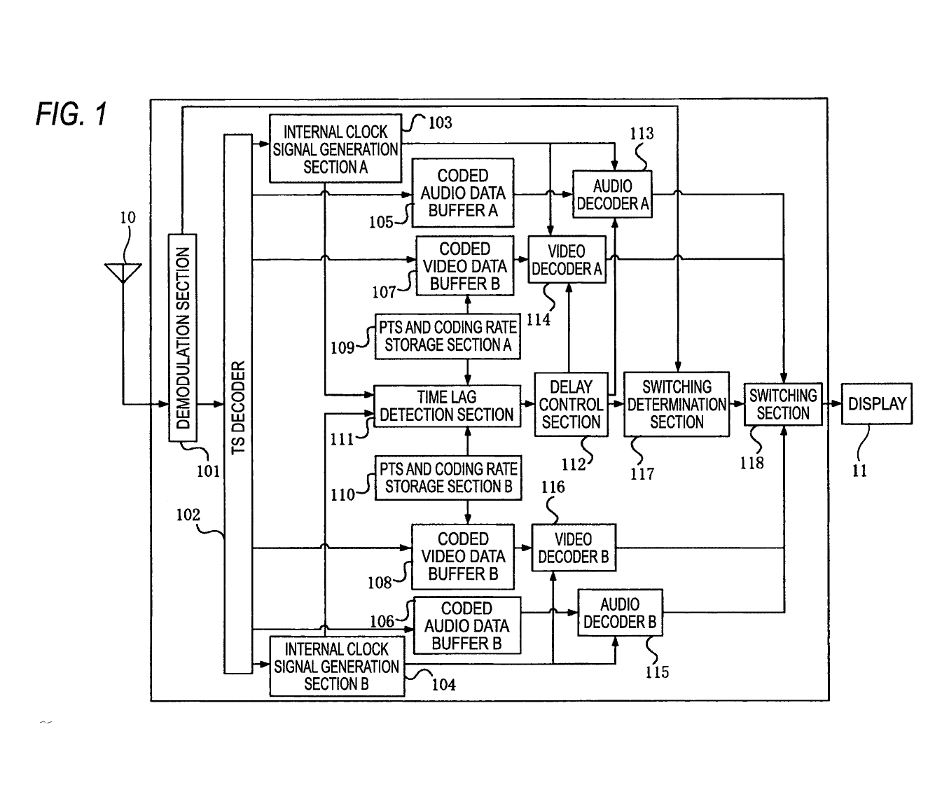

An embodiment of the present invention is hereunder described by reference to the drawings. FIG. 1 is a block diagram showing a configuration of a digital broadcast receiver of an embodiment of the present invention.

In FIG. 1, the digital broadcast receiver of the present invention has an antenna 10, a display 11, a demodulation section 101, a TS decoder 102, an internal clock signal generation section A103, an internal clock signal generation section B104, a coded audio data buffer A105, a coded audio data buffer B106, a coded video data buffer A107, a coded video data buffer B108, a PTS and coding rate storage section A109, a PTS and coding rate storage section B110, a time lag detection section 111, a delay control section 112, an audio decoder A113, a video decoder A114, an audio decoder B115, a video decoder B116, a switching determination section 117, and a switching section 118.

The antenna 10 receives a digital broadcast wave.

The demodulation section 101 demodulates a digital broadcast signal received by the antenna 10 and outputs a first broadcast TS packet and a second broadcast TS packet.

The demodulation section 101 has a function of calculating a receiving quality value, such as a CN ratio (Carrier to Noise Ratio) and a BER (Bit Error Ratio) of a digital broadcast signal.

The TS decoder 102 extracts first broadcast coded audio data and first broadcast coded video data from the first broadcast TS packet and second broadcast coded audio data and second broadcast coded video data from the second broadcast TS packet output from the demodulation section 101.

From the PCR included in the first broadcast TS packet, the internal clock signal generation section A103 generates an internal clock signal that is in synchronism with the PCR. The internal clock signal generated by the internal clock signal generation section A103 is used for synchronization between a video of the first broadcast and audio of the first broadcast.

From the PCR included in the second broadcast TS packet, the internal clock signal generation section B104 generates an internal clock signal that is in synchronism with the PCR. The internal clock signal generated by the internal clock signal generation section B104 is used for synchronization between a video of the second broadcast and audio of the second broadcast.

The coded audio data buffer A105 stores first broadcast coded audio data output from the TS decoder 102. The coded audio data buffer A105 also stores a PTS imparted on a per-audio-frame basis.

The coded audio data buffer B106 stores second broadcast coded audio data output from the TS decoder 102. The coded audio data buffer B106 also stores a PTS imparted on a per-audio-frame basis.

The coded video data buffer A107 stores first broadcast coded video data output from the TS decoder 102. The coded video data buffer A107 also stores a PTS imparted on a per-video-frame basis.

The coded video data buffer B108 stores second broadcast coded video data output from the TS decoder 102. The coded video data buffer B108 also stores a PTS imparted on a per-video-frame basis.

The PTS and coding rate storage section A109 stores a coding rate and a PTS value of one frame in the first broadcast coded video data sequentially stored in the coded video data buffer A107.

The PTS and coding rate storage section B110 stores a coding rate and a PTS value of one frame in the second broadcast coded video data sequentially stored in the coded video data buffer B108.

The time lag detection section 111 calculates an output time lag between the first broadcast and the second broadcast from a time shift in the coding rate of the coded video data pertaining the first broadcast stored in the PTS and coding rate storage section A109, a time shift in the coding rate of the coded video data pertaining the second broadcast stored in the PTS and coding rate storage section B110, an internal clock signal generated by the internal clock signal generation section A103, and an internal clock signal generated by the internal clock signal generation section B104; and outputs the thus-calculated output time lag to the delay control section 112.

The delay control section 112 reports the output time lag output from the time lag detection section 111 to the audio decoder A113 and the video decoder A114.

The delay control section 112 has a function of outputting a signal for enabling the switching determination section 117 to carry out switching when an output time lag is output from the time lag detection section 111 and a function of not outputting a signal for enabling the switching determination section 117 to carry out switching when the output time lag is not output from the time lag detection section 111.

The audio decoder A113 decodes the first broadcast coded audio data stored in the coded audio data buffer A105. When an internal count value output from the internal clock signal generation section A103 has become larger than a sum of the PTS of the coded audio data stored in the coded audio data buffer A105 and the delay time output from the delay control section 112, a decoded audio frame is output to the switching section 118.

The video decoder A114 decodes the first broadcast coded video data stored in the coded video data buffer A107. When the internal count value output from the internal clock signal generation section A103 has become larger than a sum of the PTS of the coded video data stored in the coded video data buffer A107 and the delay time output from the delay control section 112, a decoded video frame is output to the switching section 118.

The audio decoder B115 decodes the second broadcast coded audio data stored in the coded audio data buffer B106. When an internal count value output from the internal clock signal generation section B104 has become larger than the PTS of the coded audio data stored in the coded audio data buffer B106, a decoded audio frame is output to the switching section 118.

The video decoder B116 decodes the second broadcast coded video data stored in the coded video data buffer B108. When the internal count value output from the internal clock signal generation section B104 has become larger than the PTS of the coded video data stored in the coded video data buffer B108, a decoded video frame is output to the switching section 118.

When a receiving quality value output from the demodulation section 101 is a given threshold value or more and when the signal for enabling switching operation is output from the delay control section 112, the switching determination section 117 outputs a switching enable signal to the switching section 118.

When the switching determination section 117 has already output the switching enable signal, the switching section 118 outputs a first broadcast audio frame output from the audio decoder A113 and a first broadcast video frame output from the video decoder A114 to the display 11. When the switching determination section 117 has not output the switching enable signal, a second broadcast audio frame output from the audio decoder B115 and a second broadcast video frame output from the video decoder B116 are output to the display 11.

The display 11 plays the audio frame output from the switching section 118 and displays the video frame output from the switching section 118.

A method for detecting a time lag of the time lag detection section 111 is hereunder described by reference to the drawings.

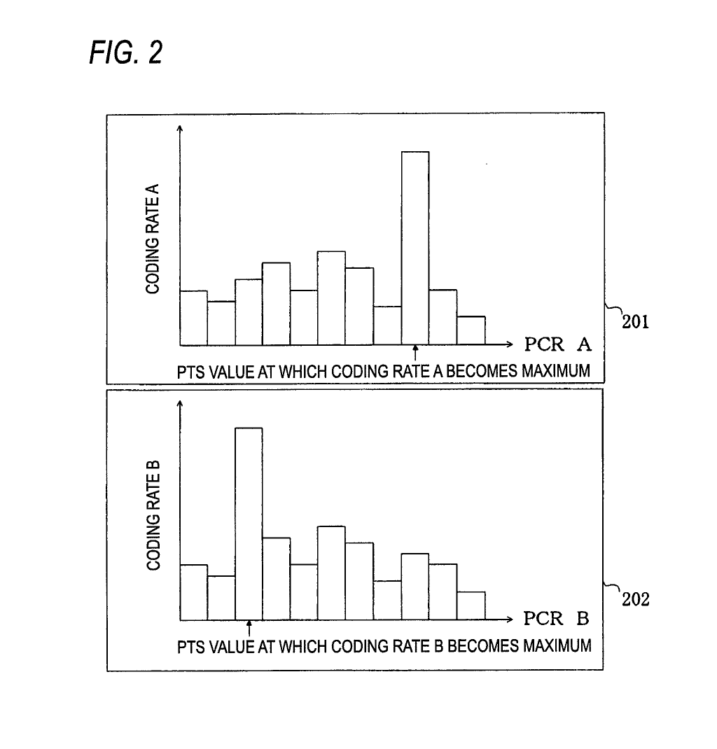

FIG. 2 is a graph showing a time shift in the coding rate of the first broadcast and a time shift in the coding rate of the second broadcast video.

Reference numeral 201 shown in FIG. 2 denotes a graph having a horizontal axis representing an internal clock value (equivalent to the PCR of the first broadcast) generated by the internal clock signal generation section A103 and a vertical axis representing an encoding rate of the coded video data. The graph shows a relationship between a coding rate of the first broadcast coded video data stored in the PTS and coding rate storage section A109 and a PTS value of the first broadcast coded video data.

Reference numeral 202 shown in FIG. 2 denotes a graph having a horizontal axis representing an internal clock value (equivalent to the PCR of the second broadcast) generated by the internal clock signal generation section B104 and a vertical axis representing an encoding rate of the coded video data. The graph shows a relationship between a coding rate of the second broadcast coded video data stored in the PTS and coding rate storage section B110 and a PTS value of the second broadcast coded video data.

Since the first broadcast and the second broadcast are not always identical with each other in terms of the PCR that is to serve as a reference time, the graph 201 and the graph 202 cannot simply be compared with each other.

In order to generate a synchronous reference time, the time lag detection section 111 determines a lag between an internal clock signal synchronous with the PCR of the first broadcast output from the internal clock signal generation section A103 and an internal clock signal synchronous with the PCR of the second broadcast output from the internal clock signal generation section B104, thereby calculating an offset (hereinafter called a “reference time offset”).

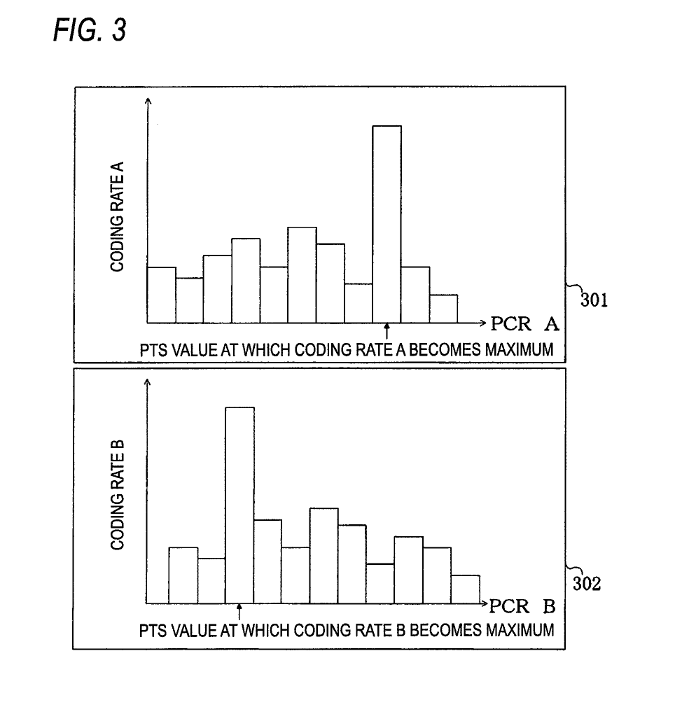

FIG. 3 shows a correction made to the time shift in the coding rate of the second broadcast coded video data shown in FIG. 2 by use of the reference time offset.

Reference numeral 301 shown in FIG. 3 denotes a graph having a horizontal axis representing an internal clock value (equivalent to the PCR of the first broadcast) generated by the internal clock signal generation section A103 and a vertical axis representing an encoding rate of the coded video data. The graph shows a relationship between a coding rate of the first broadcast coded video data stored in the PTS and coding rate storage section A109 and a PTS value of the first broadcast coded video data.

Reference numeral 302 shown in FIG. 3 denotes a graph having a horizontal axis representing an internal clock value (equivalent to the PCR of the second broadcast) generated by the internal clock signal generation section B104 and a vertical axis representing an encoding rate of the coded video data. The graph shows a relationship between a coding rate of the second broadcast coded video data stored in the PTS and coding rate storage section B110 and a PTS value of the second broadcast coded video data corrected by means of the reference time offset.

A difference between the PTS value showing the maximum coding rate in the graph 301 and the PTS value showing the maximum coding rate in the graph 302 is determined, whereby a lag between an output time of the first broadcast and an output time of the second broadcast can accurately be calculated.

As mentioned above, the digital broadcast receiver of the present embodiment makes it possible to seamless switch between simultaneous broadcasts without addition of a video comparator and an audio comparator that entail performance of enormous amounts of processing. Moreover, even when a time lag between the simultaneous broadcasts is changed or when a new broadcast station is opened, the receiver can cope with the change without necessitating a correction to a program, such as table data.

The present invention has been described in detail by reference to the specific embodiment. However, it is manifest to those skilled in the art that the present invention is susceptible to various alterations or modifications without departing the spirit and scope of the present invention.

The present patent application is based on Japanese Patent Application (JP-A-2008-091249) filed on Mar. 31, 2008, the entire subject matter of which is incorporated herein by reference.

A digital broadcast receiver of the present invention yields an advantage of the ability to seamless switching between simultaneous broadcasts without addition of devices that make a comparison of data sets pertaining to simultaneous broadcasts entailing performance of enormous amounts of processing. Moreover, the digital broadcast receiver also yields an advantage of the ability to cope with a change without necessitating a correction to a program, such as table data even when a time lag between the simultaneous broadcasts is changed or when a new broadcast station is opened. Thus, the present invention is useful as a digital broadcast receiver, or the like.

The disclosure of Japanese Patent Application No. 2008-091249 filed Mar. 31, 2008, including specification, drawings and claims is incorporated herein by reference in its entirety.

1. A digital broadcast receiver that receives and displays a digital broadcast which provides a program of single contents by different means, comprising:
a demodulation section that demodulates a first broadcast wave and a second broadcast wave and that outputs Transport Stream (hereinafter referred to as a “TS”) packets of the respective waves;
a TS decoder that extracts, from the TS packets output from the demodulation section, first broadcast coded audio data, first broadcast coded video data, second broadcast coded audio data, and second broadcast coded video data;
an internal clock signal generation section that generates an internal clock signal synchronous with a first broadcast Program Clock Reference (hereinafter referred to as a “PCR”) included in the TS packet and an internal clock signal synchronous with a second broadcast PCR included in the TS packet;
a coded video data buffer that stores the first broadcast coded video data and the second broadcast coded video data;
a coded audio data buffer that stores the first broadcast coded audio data and the second broadcast coded audio data;
a video decoder that decodes the first broadcast coded video data and the second broadcast coded video data stored in the coded video data buffer, thereby outputting a first broadcast video frame and a second broadcast video frame;
an audio decoder that decodes the first broadcast coded audio data and the second broadcast coded audio data stored in the coded audio data buffer, thereby outputting a first broadcast audio frame and a second broadcast audio frame;
a PTS and coding rate storage section that detects a per-frame coding rate and a Presentation Time Stamp (hereinafter referred to as a “PTS”) value from each of the first broadcast coded video data and the second broadcast coded video data stored in the coded video data buffer and that stores a time shift in connection with the first broadcast and a time shift in connection with the second broadcast;
a time lag detection section that detects a time lag between an output time of the first broadcast and an output time of the second broadcast from a time shift in the coding rate of the first broadcast coded video data and a time shift in the coding rate of the second broadcast coded video data, which are stored in the PTS and coding rate storage section, and also from a lag between the internal clock signal of the first broadcast and the internal clock signal of the second broadcast;
a delay control section that delays an output time of the first broadcast video frame and an output time of the first broadcast audio frame by an amount corresponding to the output time lag detected by the time lag detection section; and
a switching section that displays on a display, according to a predetermined condition, either the first broadcast video frame and the first broadcast audio frame output from the video decoder and the audio decoder while delayed by the amount corresponding to the output time lag or the second broadcast video frame and the second broadcast audio frame output from the video decoder and the audio decoder.

2. The digital broadcast receiver according to claim 1, wherein the time lag detection section detects a time lag between an output time of the first broadcast and an output time of the second broadcast from a PTS value achieved when the coding rate of the first broadcast coded video data becomes maximum through a time shift and a PTS value achieved when the coding rate of the second broadcast coded video data becomes maximum through a time shift.

3. The digital broadcast receiver according to claim 1, wherein the time lag detection section calculates a lag between a reference time of the PTS value imparted to the first broadcast video frame and the first broadcast audio frame and a reference time of the PTS value imparted to the second broadcast video frame and the second broadcast audio frame, from a lag between a value of the internal counter calculated from the PCR included in the TS packet of the first broadcast and a value of the internal counter calculated from the PCR included in the TS packet of the second broadcast.
